(19) United States
(12) Patent Application Publication
(10) Pub. No.: US 2007/0011152 A1
(43) Pub. Date: Jan. 11, 2007

(54) Device, method, and recording medium recording a program for image display

(76) Inventor: Yoshiko Ikezawa, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/483,166

(22) Filed: Jul. 7, 2006

(30) Foreign Application Priority Data
Jul. 8, 2005 (JP) 2005-200358

(51) Int. Cl. G06F 17/30

(52) U.S. Cl. 707/4

(57) ABSTRACT

An image display device for searching for and displaying images by specifying the period for capturing the target images with at least one of year, month, day, and time. In this specification, the image display device: (1) searches for images captured during the period indicated by the specified month, day, or time, though the years of capturing the images differ from one another, if at least one of month, day, and time is specified without specifying year; (2) searches for images captured during the period indicated by the specified day or time, though the years or months of capturing the images differ from one another, if at least one of day and time is specified without specifying year and month; and (3) searches for images captured during the period indicated by the specified time, though the years, months, or days of capturing the images differ from one another, if time is specified without specifying year, month, and day.

### CROSS-REFERENCE TO RELATED APPLICATION

This application is based upon and claims the benefit of priority from prior Japanese Patent Application No. 2005-200358, filed on July 8, the entire contents of which are incorporated herein by reference.

### BACKGROUND OF THE INVENTION

1. Field of the Invention

The present invention relates to an image display device, an image display method, and a recording medium recording an image display program wherein a user can easily acquire a desired image with simple operations.

2. Description of the Related Art

Conventionally, a search function has generally been used to search for a desired image. For example, if a user wants to search for and display an image captured on a specific day or in a specific time zone, he or she has entered the specific day or specific time zone into a search formula and displayed all images fulfilling the conditions. While this method is suitable for search under simple conditions, however, it has required complex search operations such as entering a complicated search formula or performing a search operation more than once in the case of search with a combination of a plurality of conditions.

Japanese Patent Laid-Open No. 2004-213631 discloses a method of improving the visibility by displaying images in a calendar form to classify the images. According to this method, the images are displayed with being classified according to dates. Therefore, it may facilitate an image search operation depending on circumstances.

In the technology described in Japanese Patent Laid-Open No. 2004-213631, the image searches are displayed with their corresponding dates in a list form, but a user has a need to find a desired image out of the displayed images. Particularly, if there are a large number of images to be searched, it is hard to find out the desired image. Therefore, it is considered that the technology in Japanese Patent Laid-Open No. 2004-213631 is still susceptible to improvement.

### BRIEF SUMMARY OF THE INVENTION

An image display device according to the present invention searches for and displays images by specifying the capturing period of the target images with at least one of year, month, day, and time. In this instance, the image display device: (1) searches for images captured during the period indicated by the specified month, day, or time, though the years of capturing the images differ from one another, if at least one of month, day, and time is specified without specifying year; (2) searches for images captured during the period indicated by the specified day or time, though the years or months of capturing the images differ from one another, if at least one of day and time is specified without specifying year and month; and (3) searches for images captured during the period indicated by the specified time, though the years, months, or days of capturing the images differ from one another, if time is specified without specifying year, month, and day.

Therefore, the image display device is capable of searching for and displaying images captured in a specific month, on a specific day, or at a specific time in a plurality of years by specifying the month, day, or time without specifying year for the capturing period of images, for example.

For example, the image display device according to the present invention displays the captured images after classifying them according to the capturing date and time. For example, the image display device includes: an image database for storing the images; an image management database for storing capturing dates for specifying year, month, and day of capturing the images and capturing time for specifying hour and minute of capturing the images; a period specification section for specifying a period for searching for the images by at least one of year, month, day, and time; an image search section for searching for the images captured during the specified period; and a thumbnail display section for displaying thumbnails of the images searched for and retrieved by the image search section, wherein the image search section: (1) searches for images captured during the period indicated by the specified month, day, or time from the images stored in the image database, though the years of capturing the images differ from one another, if the period specification section specifies the period by specifying at least one of month, day, and time without specifying year; (2) searches for images captured during the period indicated by the specified day or time from the images stored in the image database, though the years or months of capturing the images differ from one another, if the period specification section specifies the period by specifying at least one of day and time without specifying year and month; and (3) searches for images captured during the period indicated by the specified time from the images stored in the image database, though the years, months, or days of capturing the images differ from one another, if the period specification section specifies the period by specifying time without specifying year, month, and day.

Moreover, the present invention can also be understood as an image display method or a recording medium storing the program therefor.

In this specification, it is assumed that the wording “the image display device ‘specifies’ a period” includes a meaning that the image display device allows a user thereof to enter the specification of the period and accepts the period specified by the user.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a diagram showing the configuration of an image display screen according to an image display method of an embodiment of the present invention;

FIGS. 2A to 2C are diagrams each showing a module displayed in a display mode switching area;

FIG. 3 is a diagram showing a module displayed in a narrowing specification area;

FIGS. 4A and 4B are diagrams each for explaining a method of displaying retrieved images;

FIGS. 5A and 5B are diagrams each for explaining a method of displaying retrieved images;

FIG. 6 is a diagram showing a display in a display area that appears when year is specified in a year display mode;

FIG. 7 is a diagram showing a display in the display area that appears when year and month are specified in a month display mode;

FIG. 8 is a diagram showing a display in the display area related to a variation that appears when year and month are specified in the month display mode;

FIG. 9 is a diagram showing a display in the display area that appears when year and month are specified in the month display mode and Saturday and Sunday are specified in the specification of days of week for narrowing down;

FIG. 10 is a diagram showing a selected image display screen;

FIG. 11 is a diagram showing the configuration of an image display device;

FIG. 12 is a diagram showing the configuration of an image management database (DB);

FIG. 13 is a flowchart showing a general procedure for image display processing;

FIG. 14 is a flowchart showing a general procedure for image display processing;

FIG. 15 is a flowchart showing a general procedure for initialization;

FIG. 16 is a flowchart showing a general procedure for display mode switching area processing;

FIG. 17 is a flowchart showing a general procedure for display area display switching processing;

FIG. 18 is a flowchart showing a general procedure for calendar display processing with omission of unnecessary areas;

FIG. 19 is a flowchart showing a general procedure for search for target images to which the search is narrowed down;

FIG. 20 is a flowchart showing a general procedure for display area processing; and

FIG. 21 is a flowchart showing a general procedure for selected image display screen processing.

### DETAILED DESCRIPTION OF THE PREFERRED EMBODIMENTS

A preferred embodiment of the invention is described below with reference to the accompanying drawings.

In an image display method according to the preferred embodiment of the present invention, a user performs an image search operation based on an image display screen displayed on a display section of an image display device.

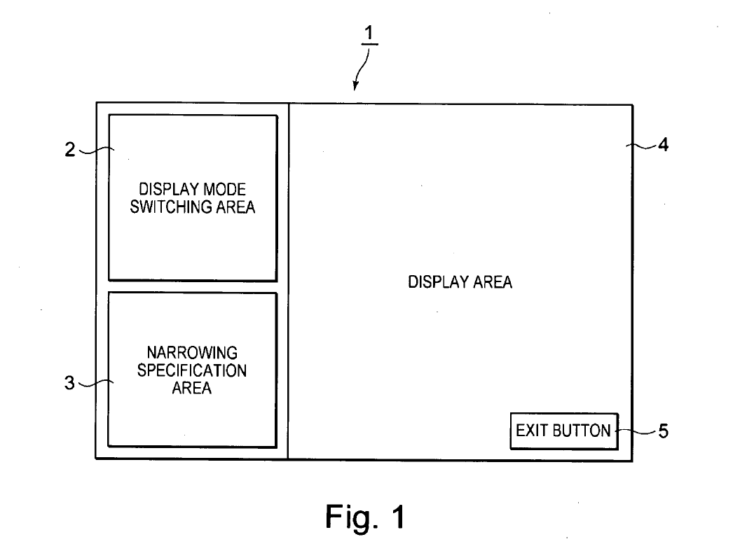

Referring to FIG. 1, there is shown a diagram illustrating the configuration of the image display screen according to the image display method of the preferred embodiment of the present invention.

The image display screen 1 has a display mode switching area 2, a narrowing specification area 3, a display area 4, and an Exit button 5.

The display mode switching area 2 is for use in displaying a module for specifying a form (display mode) in which classified images are displayed. The narrowing specification area 3 is for use in displaying a module for setting with search conditions narrowed down. The display area 4 is for use in displaying images in the display mode or images as a search result. The Exit button 5 is an operation button for exiting the image display screen 1.

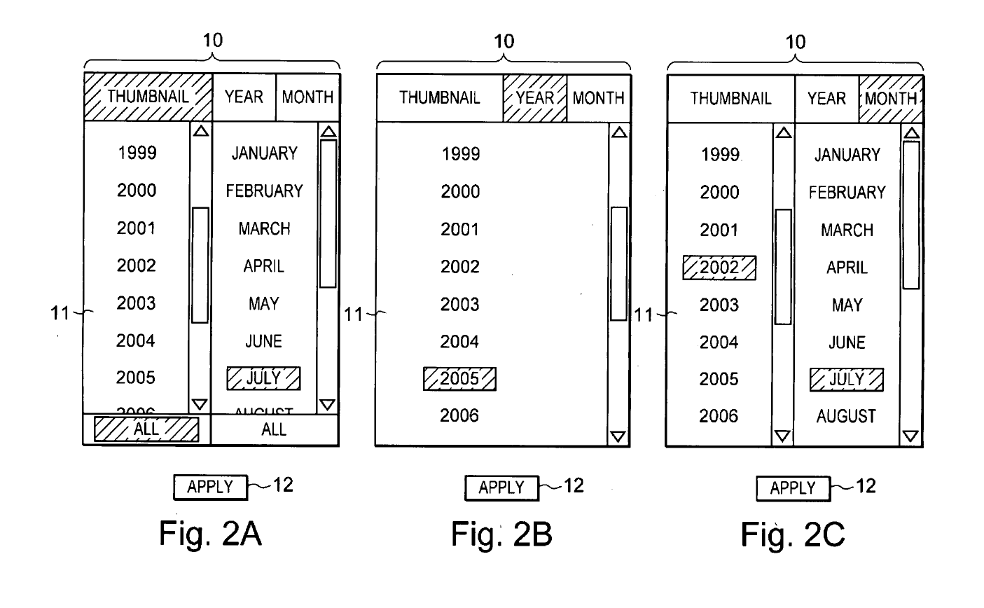

Referring to FIGS. 2A to 2C, there are shown diagrams illustrating modules displayed in the display mode switching area 2.

The display mode switching area 2 has a mode switching button 10, a year and month selection module 11, and an Apply button 12.

The mode switching button 10 includes a Thumbnail button, a Year button, and a Month button. A user can select a thumbnail display mode, a year display mode, or a month display mode by operating each of these buttons. These display modes are for use in displaying images in the display area 4. Moreover, it is possible to switch the display of a year and month selection module 11 according to the display mode.

Referring to FIG. 2A, there is shown a module in the thumbnail display mode. The thumbnail display mode is for use in searching for images each having year and month specified by the user as a capturing date and displaying the thumbnails of retrieved images in the display area 4.

The user can select desired year and month from the year and month selection module 11. Moreover, the user can eliminate year and month from the search conditions by operating ALL at the bottom of the year and month selection module 11. Upon the operation of the year and month selection module 11, a search for the images satisfying the selection conditions of the year and month selection module 11 starts and the list of thumbnails of retrieved images are then displayed in the display area 4. By operating the Apply button 12 thereafter, the retrieved images are stored as target images for subsequent search operations.

Referring to FIG. 2B, there is shown a module in the year display mode. The year display mode is for use in searching for images each having year specified by the user as a capturing date and displaying the presence or absence of the images in a calendar form in the display area 4.

The user can select desired year from the year and month selection module 11. Upon the operation of the year and month selection module 11, a search for the images satisfying the selection conditions of the year and month selection module 11 starts and retrieved images are then displayed in the calendar form in the display area 4. By operating the Apply button 12 thereafter, the retrieved images are stored as target images for subsequent search operations.

Referring to FIG. 2C, there is shown a module in the month display mode. The month display mode is for use in searching for images each having year and month specified by the user as a capturing date and displaying the thumbnails of retrieved images in the calendar form of the month in the display area 4.

The user can select desired year and month from the year and month selection module 11. Upon the operation of the year and month selection module 11, a search for the images satisfying the selection conditions of the year and month selection module 11 starts and retrieved images are then displayed in the calendar form of the calendar in the display area 4. By operating the Apply button 12 thereafter, the retrieved images are stored as target images for subsequent search operations.

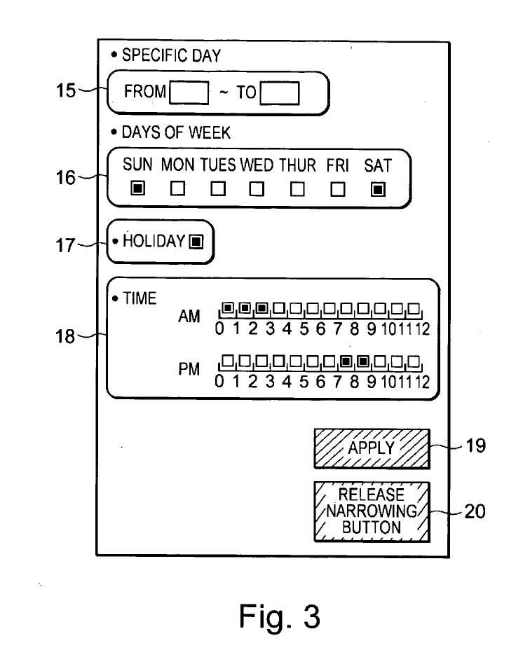

Referring to FIG. 3, there is shown a module displayed in the narrowing specification area 3.

The narrowing specification area 3 includes a specific day specification area 15, a day-of-week specification area 16, a holiday specification area 17, a time specification area 18, an Apply button 19, and a Release Narrowing button 20.

The user can input a period for specifying dates in the specific day specification area 15. Images captured during this period are retrieved from the search target images.

The user can specify and input days of week in the day-of-week specification area 16. Images captured on the days of week are retrieved from the search target images.

The user can specify a holiday in the holiday specification area 17. If the user specifies a holiday in the holiday specification area 17, images captured on holidays are retrieved from the search target images.

The user can specify a time zone in the time specification area 18. If the user specifies the time zone in the time specification area 18, images captured in the time zone are retrieved from the search target images.

If the user operates the Apply button 19, images satisfying the search conditions entered in the specific day specification area 15, the day-of-week specification area 16, the holiday specification area 17, and the time specification area 18 are retrieved from the search target images. By operating the Release Narrowing button 20, the user can release the specification of the narrowing specification area 3.

The following describes the above display modes and the method of displaying the images retrieved under the search conditions.

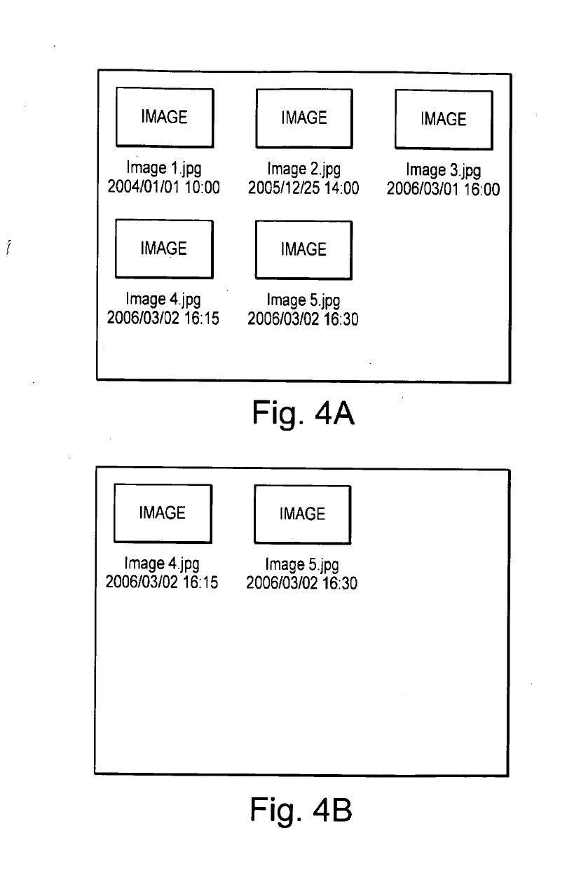

Referring to FIG. 4A, there is shown a display of the display area 4 that appears when the thumbnail display mode is specified and ALL is specified for the year and month specification. The display area 4 shows image IDs and capturing dates and times together with thumbnails.

Referring to FIG. 4B, there is shown a display of the display area 4 that appears when the images are narrowed down by specifying March 2 in the specific day specification area 15.

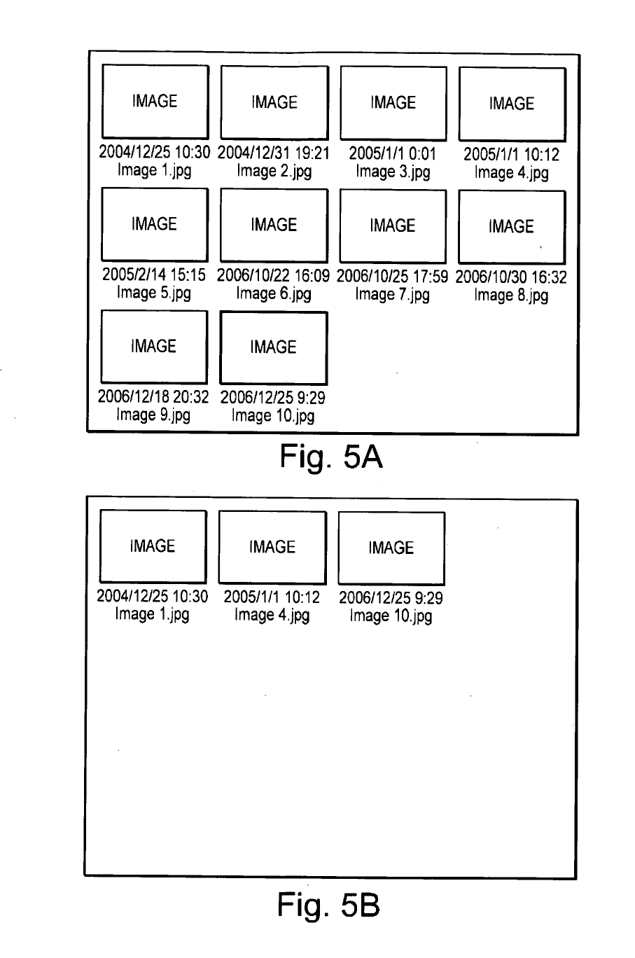

Referring to FIG. 5A, there is shown a display of the display area 4 that appears when the thumbnail display mode is specified and ALL is specified for the year and month specification for another image group. The display area 4 shows image IDs and capturing dates and times together with thumbnails.

Referring to FIG. 5B, there is shown a display of the display area 4 that appears when the images are narrowed down by specifying 9:00 to 11:00 in the time specification area 18.

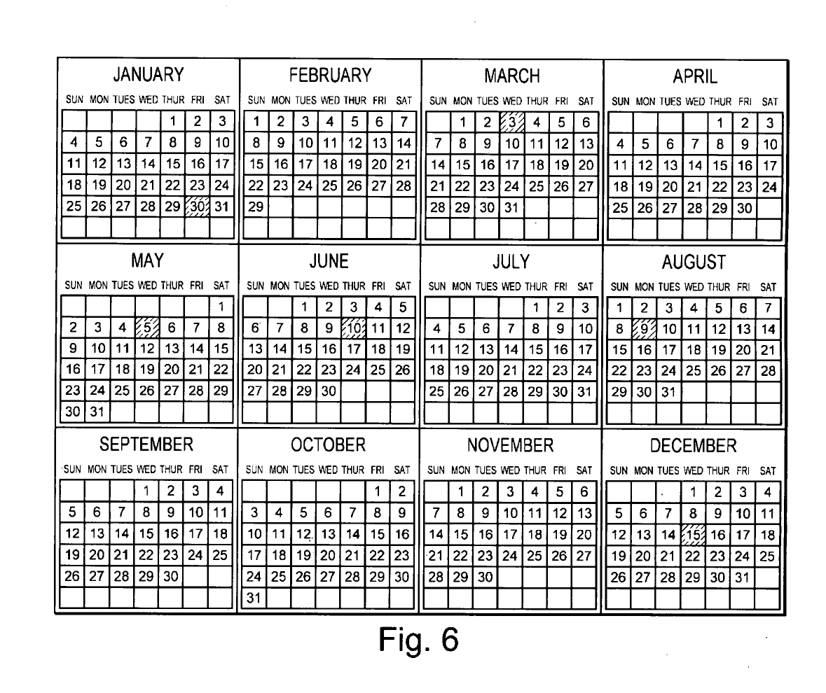

Referring to FIG. 6, there is shown a display of the display area 4 that appears when year is specified in the year display mode.

A calendar corresponding to the year selected by the year and month selection module 11 is displayed in the display area 4: if there is any image captured in the year, the date on the calendar corresponding to the capturing date and time is displayed in a different color from others.

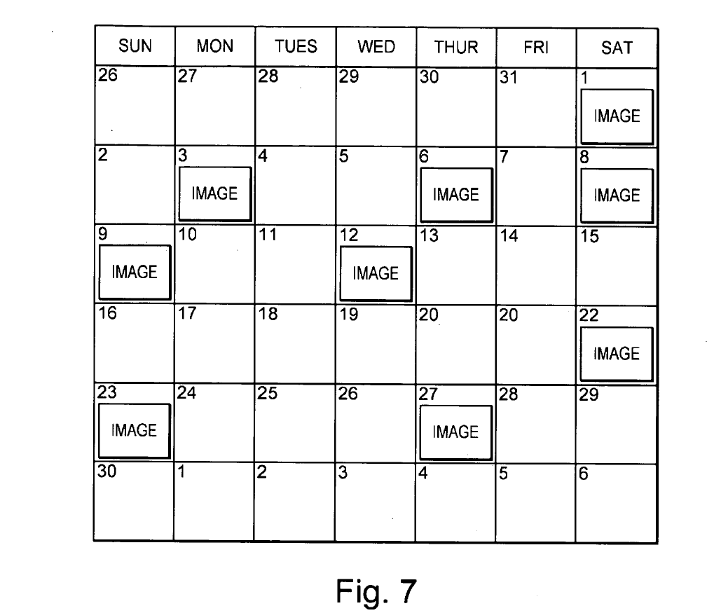

Referring to FIG. 7, there is shown a display of the display area 4 that appears when year and month are specified in the month display mode.

If the calendar for the month corresponding to the year and month selected in the year and month selection module 11 is displayed in the display area 4 and there is any image captured in the month, its thumbnail is displayed in the date position on the calendar corresponding to the capturing date and time. If there are a plurality of images captured on the corresponding day, the thumbnail of a representative image is displayed. Note here that the representative image can be selected based on various criteria. For example, it is possible to select an image captured first on the day, an image selected at random, or an image captured last on the day.

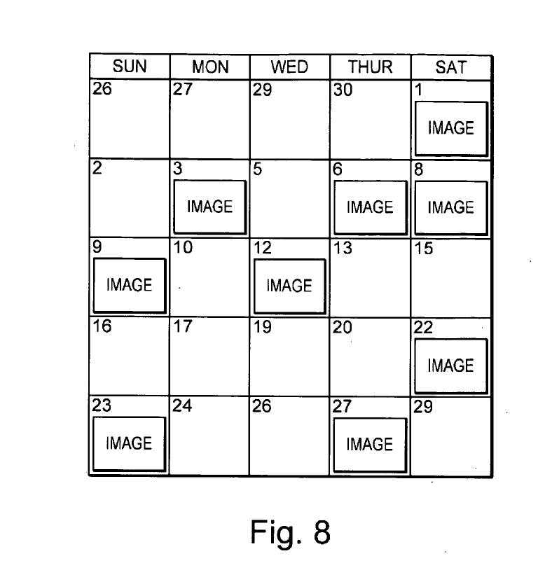

Referring to FIG. 8, there is shown a display of the display area 4 related to a variation that appears when year and month are selected in the month display mode.

If the calendar for the month corresponding to the year and month selected in the year and month selection module 11 is displayed in the display area 4 and there is any image captured in the month, its thumbnail is displayed in the date position of the calendar corresponding to the capturing date and time. If there is no thumbnail in the row or column, the row or column is not displayed. In FIG. 8, there is no thumbnail in the Friday column and the row from the 30th on the calendar, and therefore the column and row are not displayed.

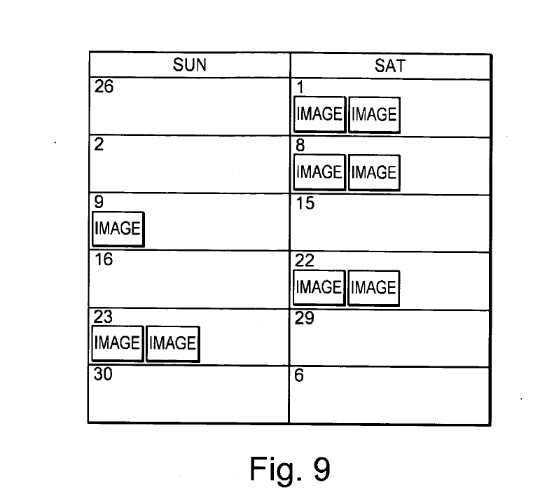

Referring to FIG. 9, there is shown a diagram illustrating a display of the display area that appears when year and month are specified in the month display mode and Saturday and Sunday are specified in the day-of-week specification to narrow the search.

The Sunday and Saturday columns are displayed without displaying the Monday to Friday columns. This provides a wider space for displaying thumbnails, whereby a plurality of thumbnails are displayed.

The following describes actions caused by user's selecting operations in the display area 4.

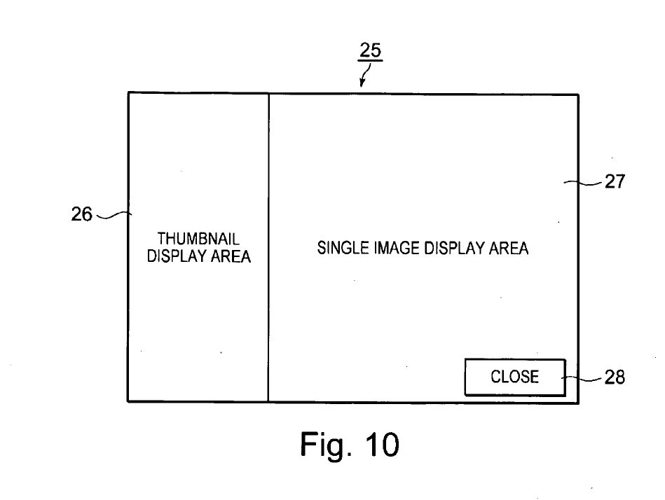

When the user selects a thumbnail in the display area 4 or selects a date on a calendar where a thumbnail exists, the selected image display screen 25 shown in FIG. 10 appears.

The selected image display screen 25 includes a thumbnail display area 26, a single image display area 27, and a Close button 28. The thumbnail display area 26 shows selected thumbnails and the single image display area 27 shows the main image of the thumbnails. Therefore, the user can check that the selected thumbnails are desired ones. Thereafter, the selected image display screen 25 is cleared by the operation of the Close button 28.

The following describes the configuration of an image display device for performing the above image display method and the main processing procedure therefor.

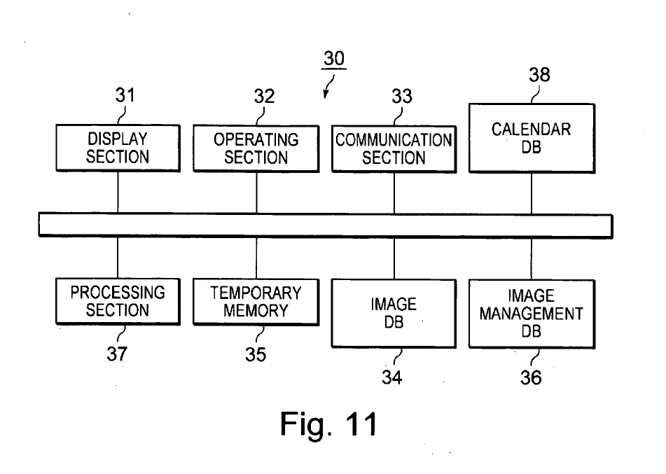

Referring to FIG. 11, there is shown a diagram of the configuration of the image display device 30. The image display device 30 includes a display section 31, an operating section 32, a communication section 33, an image database (DB) 34, a temporary memory 35, an image management database (DB) 36, a processing section 37, and a calendar database (DB) 38.

The display section 31 is a CRT or a TFT liquid crystal display for displaying an image display screen. The operating section 32 is an input device such as a keyboard or a mouse for receiving an operating instruction input from the user.

The communication section 33 is an interface for sending or receiving information such as an image file to or from an external device (not shown) through communications. The image DB 34 stores image data. The temporary memory 35 is a buffer memory for temporarily storing information necessary for image display processing. The image management DB 36 stores image management information. The processing section 37 integrally controls the operation of the image display device 30. The calendar DB 38 records information on the calendar such as days of week and holidays.

While the image display device 30 is a personal computer (PC) in this embodiment, it is not limited to this embodiment, but can be, for example, a digital camera provided with the above functions.

Subsequently, the image management information will be described.

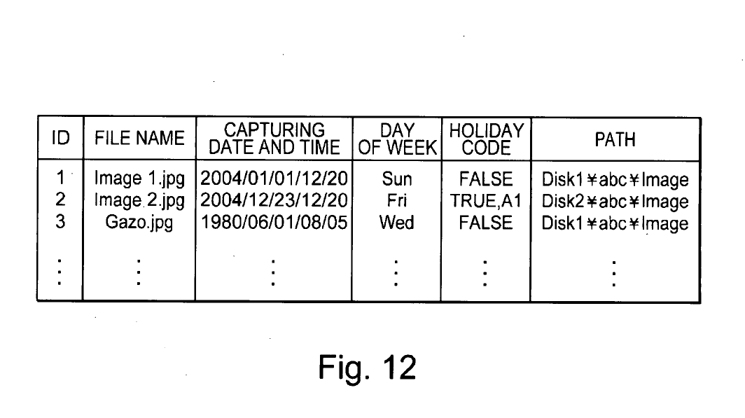

Referring to FIG. 12, there is shown a diagram illustrating the configuration of the image management DB 36 for storing the image management information.

The image management information contains an ID, a file name, capturing date and time, a day of week, a holiday code, and a path. The capturing date and time includes the capturing date for specifying year, month, and day when the image is captured and the capturing time for specifying hour and minute when the image is captured. Note here that the capturing time can include still shorter time unit information such as a second.

In this regard, the holiday code indicates that the capturing date is a holiday (TRUE) or not (FALSE). If it is a holiday, its type (a country code, a substitute holiday, a private anniversary, and so on) is entered.

The path indicates an address in the image DB where the image is stored.

The processing section 37 creates the day of week and the holiday code with reference to the calendar DB 38 based on the capturing date and time loaded together with the image, for example, when the image is loaded from the external device through the communication section 33.

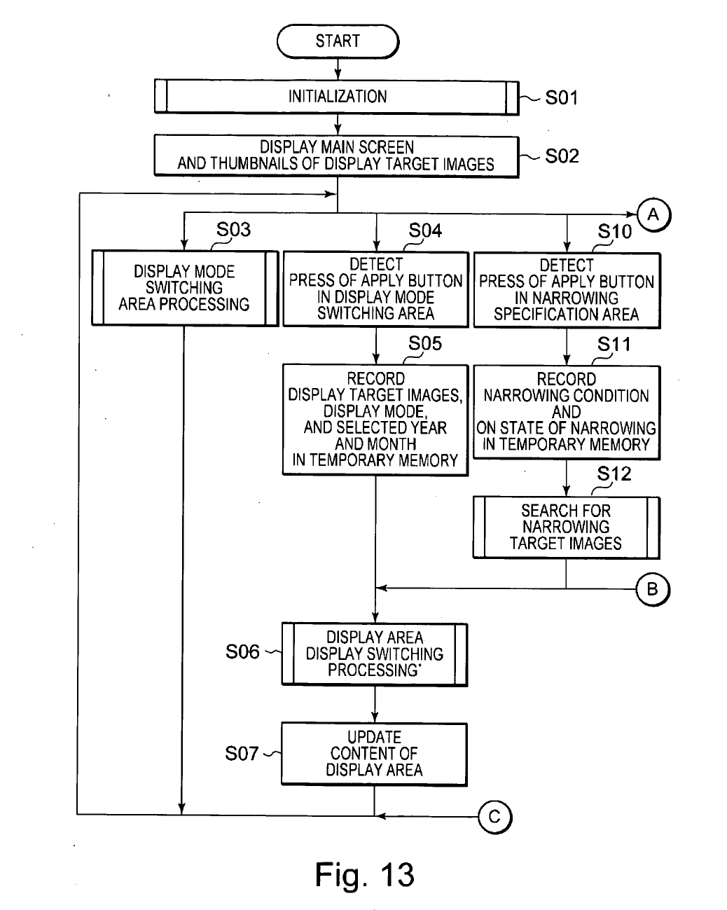

The following describes the general procedure of image display processing for performing the above image display method with reference to FIGS. 13 to 21. The processing described below is related to the main functions of the image display processing functions. Therefore, the image display processing functions include functions described with reference to FIG. 1 to FIG. 12 even if they are not described below.

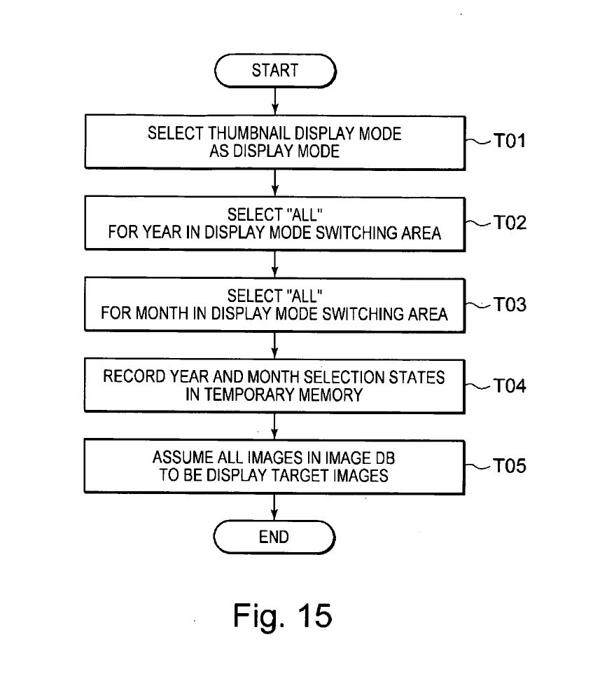

Upon the activation of the image display device 30, the processing section 37 performs initialization (FIG. 15) in step S01 in FIG. 13.

In step T01 in FIG. 15, the processing section 37 selects the thumbnail display mode as a display mode. In steps T02 to T03, it selects ALL for year and month selections in the year and month selection module 11 in the display mode switching area 2. Then, in step T04, the processing section 37 stores the display mode and the year and month selection states in the temporary memory 35. In step T05, it assumes all images stored in the image DB 34 to be display target images.

Returning to FIG. 13, the processing section 37 displays the image display screen 1 to display thumbnails of the display target images in the display area 4 in step S02. Thereafter, the control awaits the next operating instruction input from the user.

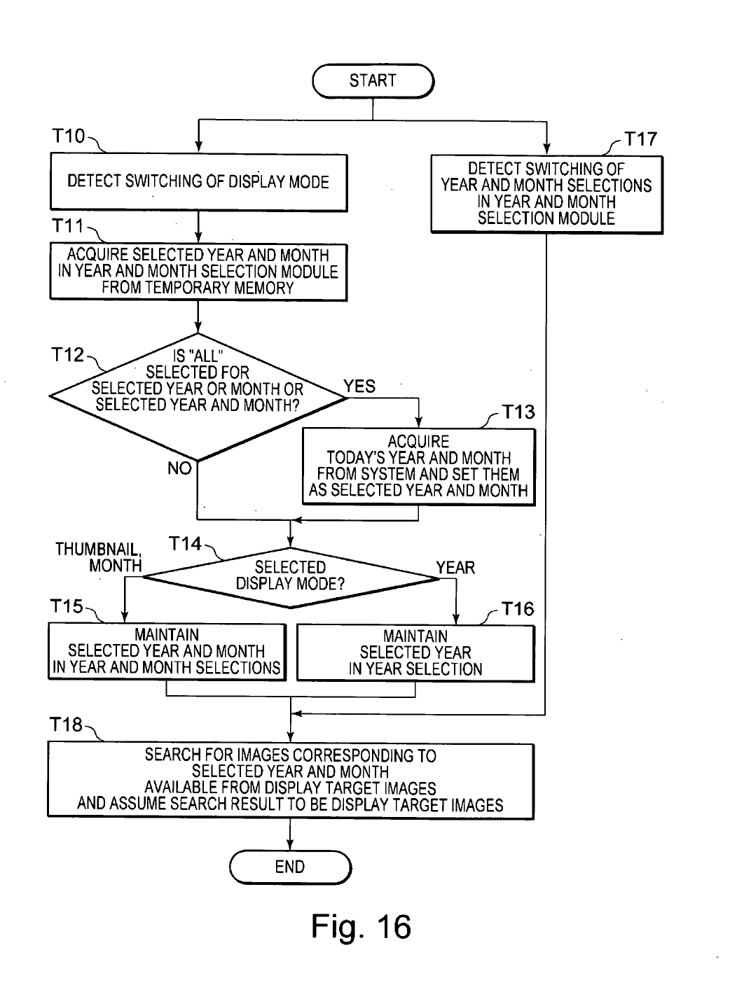

If the user operates the mode switching button 10 or the year and month selection module 11 in the display mode switching area 2, the processing section 37 performs the display mode switching area processing (FIG. 16) shown in step S03.

Upon detecting that the user switched the display mode by operating the switching button 10 in step T10 in FIG. 16, the processing section 37 retrieves the selected year and month in the year and month selection module 11 from the temporary memory 35 in step T11. Then, in step T12, it is checked whether ALL is selected for at least one of the selected year and the selected month in step T12.

If YES in step T12, or if ALL is selected for at least one of the selected year and the selected month, since the mode before the switching is the thumbnail mode, in which year and month are not specified, the processing section 37 acquires today's year and month from the system in step T13 and sets them as year and month of the year in the month selection module 11.

Subsequently, the processing section 37 checks the display mode selected by the user in step T14.

If the thumbnail display mode or the month display mode is selected as the display mode, the year and month selected in the year and month selections are maintained in step T15. On the other hand, if the year display mode is selected as the display mode, the year selected in the year selection is maintained in step T16.

In step T18, the processing section 37 searches for images each having the selected year and month as the capturing year and month available from the display target images and assumes the corresponding images to be new display target images.

Upon detecting that the user changed the year and month selections by operating the year and month selection module 11 in step T17 in FIG. 16, the processing section 37 searches for images having the selected year and month as capturing year and month available from the display target images and assumes the corresponding images to be new display target images in step T18.

Thereafter, returning to FIG. 13, the control awaits the next operating instruction input from the user.

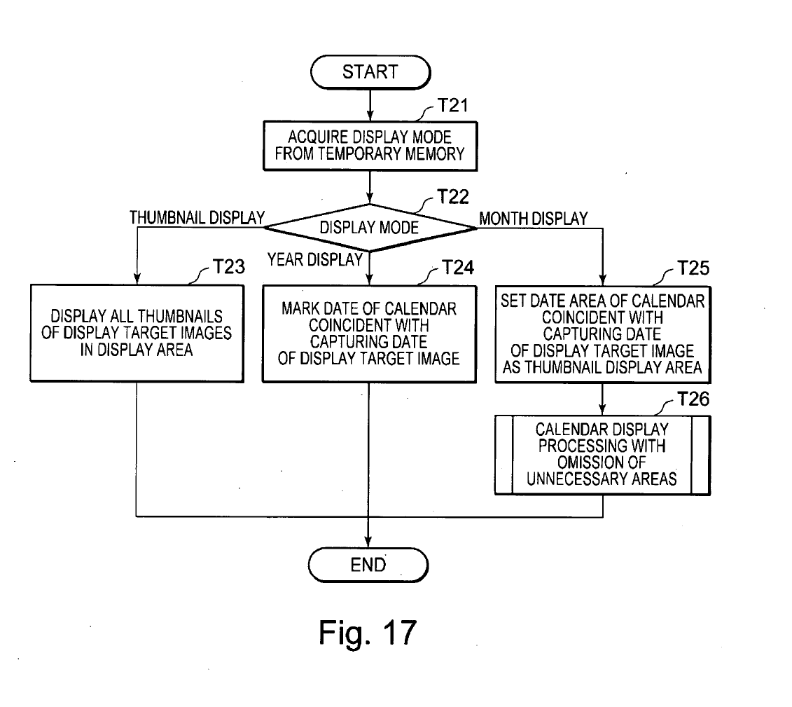

If the user presses the Apply button 12 in the display mode switching area 2 in step S04 in FIG. 13, the processing section 37 stores the display target images, the display mode, and the selected year and month in the temporary memory 35 in step S05. It then performs the display area display switching processing (FIG. 17) shown in step S06.

In step T21 in FIG. 17, the processing section 37 acquires the display mode from the temporary memory 35 and checks the display mode.

If the thumbnail display mode is selected as the display mode, the processing section 37 generates the thumbnails of the display target images in the temporary memory 35 and displays all the thumbnails in the display area 4 in step T23.

If the year display mode is selected as the display mode, the processing section 37 displays the calendar corresponding to the selected year in the display area 4 with a mark appended to the date area of the calendar coincident with the capturing date of the display target image or with the corresponding date area displayed in a different color in step T24.

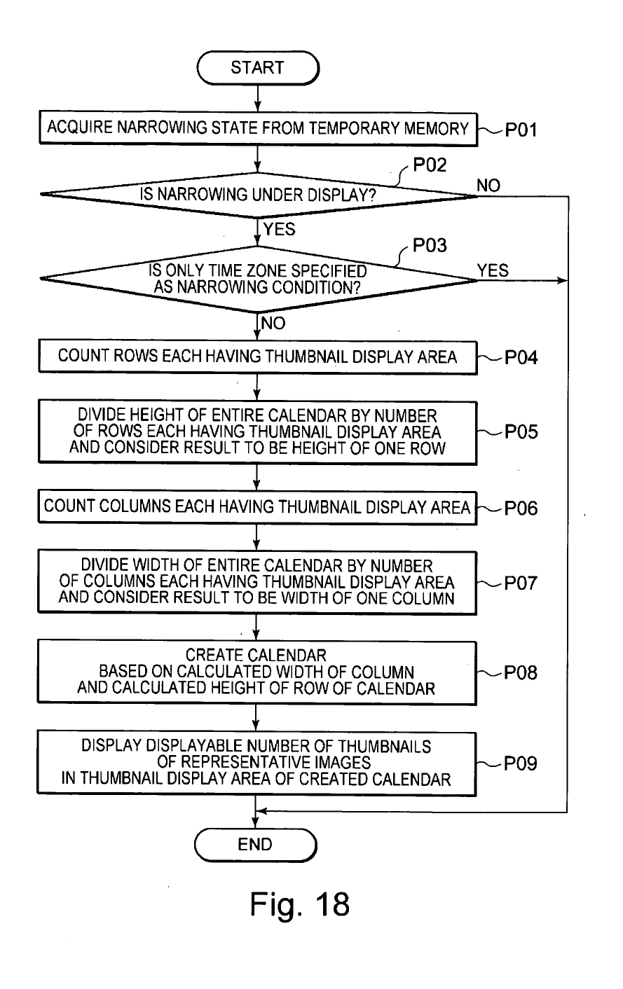

If the month display mode is selected as the display mode, the processing section 37 sets the date area of the calendar coincident with the capturing date of the display target image as a thumbnail display area regarding the calendar for the month corresponding to the selected year and month in step T25. Thereafter, it performs the calendar display processing with omission of unnecessary areas in step T26 (FIG. 18).

In step P01 in FIG. 18, the processing section 37 reads the operational state of the narrowing specification area 3 from the temporary memory 35. If NO in step P02, or if the narrowing specification area 3 is not operated, the control terminates the calendar display processing with omission of unnecessary areas. If YES in step P03, or if only the time zone is specified as the narrowing condition, the control terminates the calendar display processing with omission of unnecessary areas.

If the narrowing specification area 3 is operated and the narrowing condition is not the time zone only, the processing section 37 performs the calendar display processing with omission of unnecessary areas.

In steps P04 to P05, the processing section 37 counts the number of rows each having an area where a thumbnail is displayed in the calendar and divides the height of the entire calendar by the counted number of rows to obtain the height of one row. In steps P06 to P07, the processing section 37 counts the number of columns each having an area where a thumbnail is displayed in the calendar and divides the width of the entire calendar by the counted number of columns to obtain the width of one column. Then, in steps P08 to P09, the processing section 37 creates a calendar based on the calculated width of one column and the calculated height of one row of the calendar and displays a displayable number of thumbnails in the thumbnail display area of the created calendar.

Returning to FIG. 13, in step S07, the processing section 37 updates the display content of the display area 4 and the control awaits the next operating instruction input from the user.

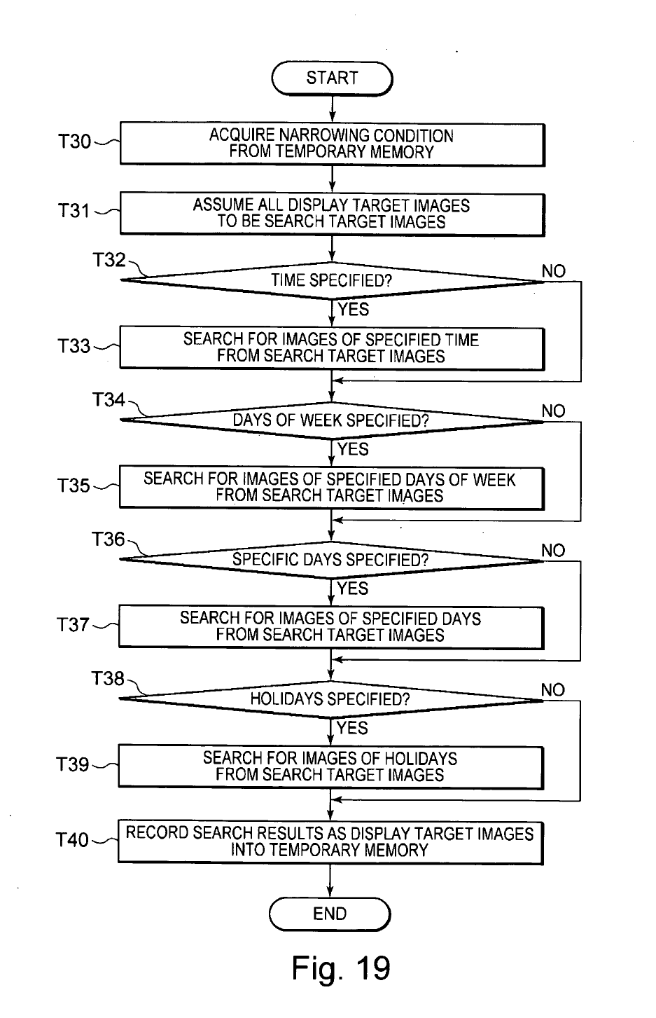

In step S10 in FIG. 13, if the user presses the Apply button 19 after setting the narrowing condition in the narrowing specification area 3, the processing section 37 records the narrowing condition and a narrowing status flag indicating that narrowing is underway into the temporary memory 35 in step S11. Thereafter, the processing section 37 performs the search processing (FIG. 19) for the narrowing target images shown in step S12.

In steps T30 to T31 in FIG. 19, the processing section 37 acquires the narrowing condition from the temporary memory 35 and assumes all the display target images to be search target images.

If YES in step T32, or if the time zone for narrowing is specified, the processing section 37 searches for the images captured at the specified time from the search target images in step T33 and assumes the images of the search result to be new search target images. If YES in step T34, or if days of week for narrowing are specified, the processing section 37 searches for images captured on the specified days of week from the search target images in step T35 and assumes the images of the search result to be new search target images. If YES in step T36, or if specific days for narrowing are specified, the processing section 37 searches for the images captured on the specified days from the search target images in step T37 and assumes the images of the search result to be new search target images. If YES in step T38, or if holidays are specified, the processing section 37 searches for the images captured on the holidays from the search target images in step T39 and assumes the images of the search result to be new search target images. Then, the processing section 37 records the search results as display target images into the temporary memory 35.

Returning to FIG. 13, the processing section 37 performs display area display switching processing (FIG. 17) in step S06. The display area display switching processing has already been described and therefore the detailed description is omitted here. Then, in step S07, the processing section 37 updates the display content of the display area 4 and the control awaits the next operating instruction input from the user.

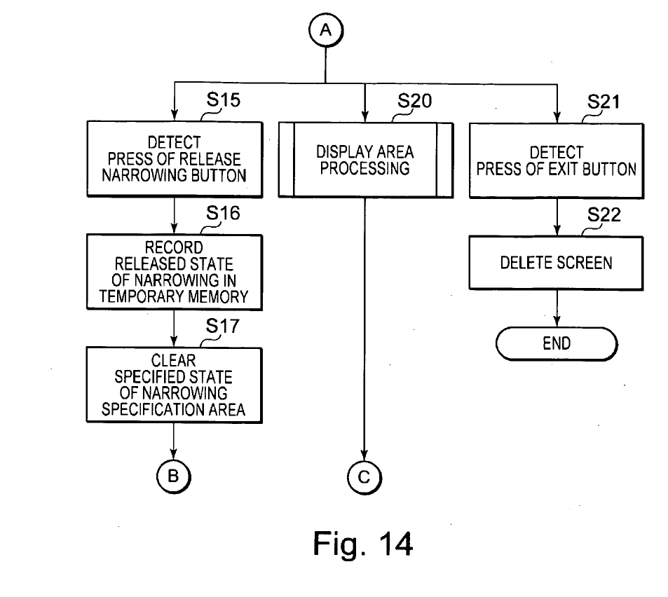

Upon detecting that the user presses the Release Narrowing button 20 in the narrowing specification area 3 in step S15 in FIG. 14, the processing section 37 releases the ON state of the narrowing status flag by the recognition that the narrowing is released and clears the specified state of the narrowing specification area 3 in steps S16 to S17. Then, the control returns to FIG. 13 and awaits the next operating instruction input from the user.

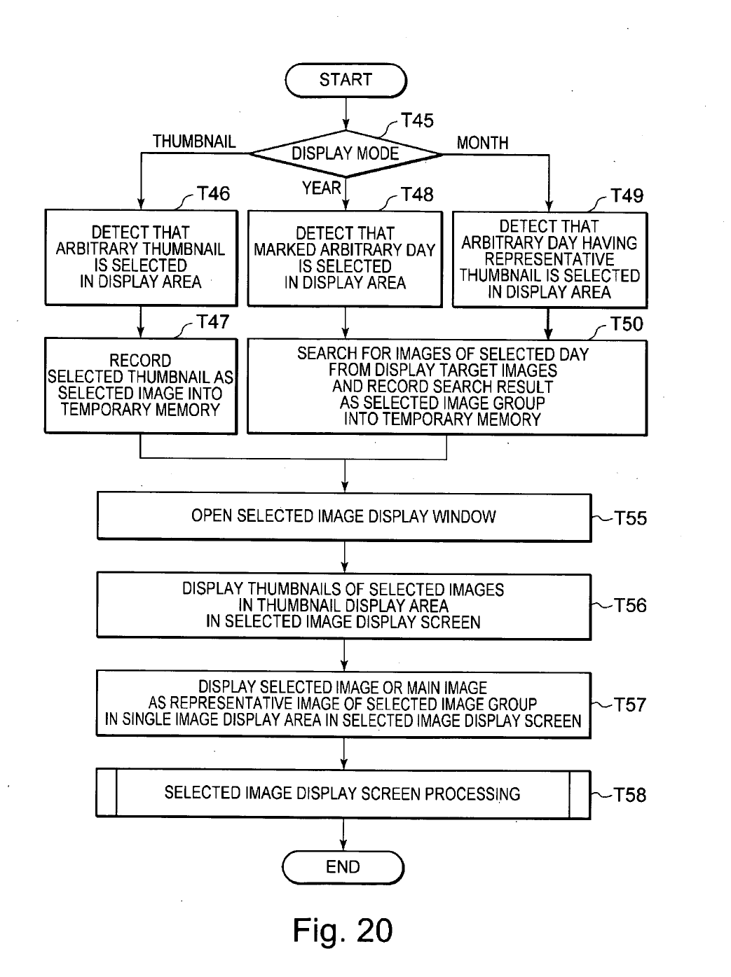

If the user selects thumbnails in the display area 4, the processing section 37 performs display area processing (FIG. 20) shown in step S20 in FIG. 14.

In step T45 in FIG. 20, the display mode is checked.

If the thumbnail display mode is selected as the display mode, the processing section 37 detects that the thumbnails are selected in the display area 4 in step T46 and records the selected thumbnails as selected images into the temporary memory in step T47.

If the year display mode is selected as the display mode, the processing section 37 detects that a marked arbitrary day is selected in the display area 4 in step T48 and searches for images captured on the selected day from the display target images and then records the search result as a selected image group into the temporary memory in step T50.

If the month display mode is selected as the display mode, the processing section 37 detects that an arbitrary day having the representative thumbnail is selected in the display area 4 in step T49 and searches for images captured on the selected day from the display target images and then records the search result as a selected image group into the temporary memory in step T50.

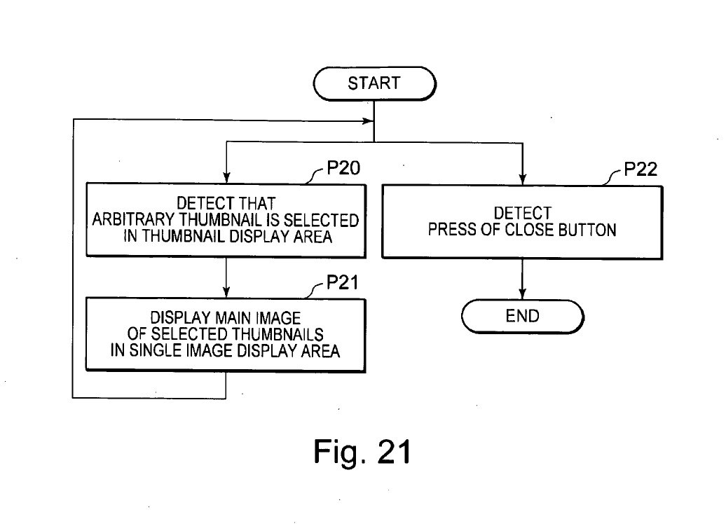

Subsequently in step T55, the processing section 37 opens the window of the selected image display screen 25 to display the thumbnails of the selected images in the thumbnail display area 26 in step T56. Then, in step T57, it displays the selected image or the main image as the representative image of the selected image group in the single image display area 27. Thereafter, the processing section 37 performs the selected image display screen processing (FIG. 21) shown in step T58.

If the user selects an arbitrary thumbnail in the thumbnail display area, the processing section 37 detects that the arbitrary thumbnail is selected in the thumbnail display area in step P20 in FIG. 21 and displays the main image of the selected thumbnails in the single image display area 27 in step P21.

If the user presses the Close button 28, the processing section 37 detects the press of the Close button in step P22 and deletes the selected image display screen 25. Then, the control returns to FIG. 13 to await the next operating instruction input from the user.

If the user operates the Exit button 5, the processing section 37 detects the press of the Exit button in step S21 in FIG. 14, deletes the image display screen 1 in step S22, and terminates the image display processing.

The functions described in the above embodiment can be configured by means of hardware or can be achieved by a program including the functions read into a computer by means of software. Moreover, the functions can be configured in such a way that either software or hardware is selected appropriately.

Furthermore, it is also possible to achieve the functions by causing a program in a recording medium to be read into a computer. In this regard, if only the program can be recorded into the recording medium and it is a computer-readable recording medium, any recording format is available.

The present invention is not limited to the exact forms described in the above embodiments, but its constituent elements can be modified within the scope of the invention in practical phase. Moreover, various inventions can be formed by proper combinations of a plurality of constituent elements disclosed in the above embodiments. For example, several constituent elements may be omitted from all the constituent elements in different embodiments. Furthermore, constituent elements in different embodiments may be combined appropriately.

The narrowing specification area 3 in the image display screen 1 shown in FIG. 1 can also be recognized as a period specification section for specifying the period for searching for images by at least one of year, month, day, and time.

The processing section 37 shown in FIG. 11 can also be recognized as an image search section for searching for images captured during the specified period.

The display area 4 of the image display screen 1 shown in FIG. 1 can be recognized as follows: a calendar display section for displaying a calendar for any year or month; a date selecting section for selecting a date of the calendar; and a second thumbnail display section for displaying the list of thumbnails of the images captured on the same day as the date selected by the date selecting section.

While there has been shown and described what are considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An image display device for displaying captured images after classifying them according to the capturing date and time, comprising:
an image database for storing the images;
an image management database for storing capturing dates for specifying year, month, and day of capturing the images and capturing time for specifying hour and minute of capturing the images;
a period specification section for specifying a period for searching for the images by at least one of year, month, day, and time;
an image search section for searching for the images captured during the specified period; and
a thumbnail display section for displaying thumbnails of the images searched for and retrieved by the image search section,
wherein the image search section:
searches for images captured during the period indicated by the specified month, day, or time from the images stored in the image database, though the years of capturing the images differ from one another, if the period specification section specifies the period by specifying at least one of month, day, and time without specifying year;
searches for images captured during the period indicated by the specified day or time from the images stored in the image database, though the years or months of capturing the images differ from one another, if the period specification section specifies the period by specifying at least one of day and time without specifying year and month; and
searches for images captured during the period indicated by the specified time from the images stored in the image database, though the years, months, or days of capturing the images differ from one another, if the period specification section specifies the period by specifying time without specifying year, month, and day.

2. The image display device according to claim 1, wherein the period specification section specifies the day by a day of week or a date.

3. The image display device according to claim 2, further comprising:
a calendar display section for displaying a calendar for any year or month;
a date selecting section for selecting a date of the calendar; and
a second thumbnail display section for displaying a list of thumbnails of the images captured on the same day as the date selected by the date selecting section.

4. The image display device according to claim 3, wherein the calendar display section does not display all or a part of the corresponding date area of the calendar if there is no image captured on the same day as the date among the calendar dates.

5. The image display device according to claim 4, further comprising a calculation section for calculating the number of the thumbnails displayed in each date area according to the size of the displayed calendar regarding the calendar for the month, wherein the second thumbnail display section displays the calculated number of thumbnails in the date area.

6. A recording medium storing an image display program for displaying captured images after classifying them according to the capturing date and time, the program causing a computer to:
store the images;
store capturing dates for specifying year, month, and day of capturing the images and capturing time for specifying hour and minute of capturing the images;
specify a period for searching for the images by at least one of year, month, day, and time;
search for the images captured during the specified period; and
display thumbnails of the images searched for and retrieved in the image search step,
wherein, in the image search, the program causes the computer to:
search for images captured during the period indicated by the specified month, day, or time from the stored images, though the years of capturing the images differ from one another, if the period is specified by specifying at least one of month, day, and time without specifying year;
search for images captured during the period indicated by the specified day or time from the stored images, though the years or months of capturing the images differ from one another, if the period is specified by specifying at least one of day and time without specifying year and month; and
search for images captured during the period indicated by the specified time from the stored images, though the years, months, or days of capturing the images differ from one another, if the period is specified by specifying time without specifying year, month, and day.

7. The recording medium storing the program according to claim 6, wherein the day is specified by a day of week or a date in the period specification.

8. The recording medium storing the program according to claim 7, wherein the program further causes the computer to:
display a calendar for any year or month;
select a date of the calendar; and
display a list of thumbnails of the images captured on the same day as the selected date.

9. The recording medium storing the program according to claim 8, wherein the program inhibits the computer to display all or a part of the corresponding date area of the calendar if there is no image captured on the same day as the date among the calendar dates.

10. The recording medium storing the program according to claim 9, wherein the program further causes the computer to calculate the number of the thumbnails displayed in each date area according to the size of the displayed calendar regarding the calendar for the month and to display the calculated number of thumbnails in the date area.

11. An image display method of displaying captured images after classifying them according to the capturing date and time, comprising the steps of:
storing the images;
storing capturing dates for specifying year, month, and day of capturing the images and capturing time for specifying hour and minute of capturing the images;
specifying a period for searching for the images by at least one of year, month, day, and time;
searching for the images captured during the specified period; and
displaying thumbnails of the images searched for and retrieved,
wherein the image search step includes:
searching for images captured during the period indicated by the specified month, day, or time from the stored images, though the years of capturing the images differ from one another, if the period is specified by specifying at least one of month, day, and time without specifying year;
searching for images captured during the period indicated by the specified day or time from the stored images, though the years or months of capturing the images differ from one another, if the period is specified by specifying at least one of day and time without specifying year and month; and
searching for images captured during the period indicated by the specified time from the stored images, though the years, months, or days of capturing the images differ from one another, if the period is specified by specifying time without specifying year, month, and day.

12. The image display method according to claim 11, wherein the day is specified by a day of week or a date in the period specification.

13. The image display method according to claim 12, further comprising the steps of:
displaying a calendar for any year or month;
selecting a date of the calendar; and
displaying a list of thumbnails of the images captured on the same day as the selected date.

14. The image display method according to claim 13, wherein, in the calendar display step, all or a part of the corresponding date area of the calendar is not displayed if there is no image captured on the same day as the date among the calendar dates.

15. The image display method according to claim 14, wherein the number of the thumbnails displayed in each date area is calculated according to the size of the displayed calendar regarding the calendar for the month and the calculated number of thumbnails are displayed in the date area.
